(19) United States
(12) Patent Application Publication
(10) Pub. No.: US 2008/0092426 A1
(43) Pub. Date: Apr. 24, 2008

(54) Animal scent disperser

(75) Inventors: Kemper O. Modlin, (US); Leo J. Niekerk, (US)

Correspondence Address: BURLESON COOKE L.L.P., 2040 NORTH LOOP 336 WEST, SUITE 123, CONROE, TX, 77304, US

(73) Assignee: Buckmister LLC

(21) Appl. No.: 11/704,788

(22) Filed: Feb. 9, 2007

Related U.S. Application Data
(63) Continuation-in-part of application No. 11/583,386, filed on Oct. 19, 2006.

(51) Int. Cl. A01M 31/00

(52) U.S. Cl. 43/1

(57) ABSTRACT

Apparatus for attracting wild game, such as deer, to a selected area is provided. A liquid attractant for the game is pumped or otherwise drawn from a reservoir through a nozzle for dispersal as a mist in or near the area. A battery-powered pump or pressurized gas source may be activated remotely.

This application is a Continuation-in-Part of U.S. patent application Ser. No. 11/583,386, filed Oct. 19, 2006.

### BACKGROUND OF THE INVENTION

1. Field of the Invention

The present invention relates to apparatus and method for use in hunting wild animals. More particularly, apparatus for pumping a spray of animal attractant into the air when activated by a remote operator is provided.

2. Description of Related Art

The use of attractants for wild animals is widely known. One well-known procedure, for example, is the placing of urine from female deer to attract bucks into an area where hunters are located. Other procedures and attractants are used for other wild animals.

A wide variety of techniques has been suggested for placing the attractant, which is normally a liquid. One simple approach is for the hunter to pour the attractant onto one or more pads and to attach the pads to trees around the hunting site. The problem with this method is that no true dispersal of the pheromones takes place. The liquid applied to the pads dries rapidly and the pad becomes ineffective. Another product on the market uses pre-packaged aerosol cans filled with scented liquid. The can may be attached to a battery-operated device to push the button on the can, which in turn disperses the scent. A few limitations of this method of application are that the product in the aerosol can lack the freshness of other attractants, decreasing its effectiveness. Another limitation is the lack of choices the canned attractants provide, since all scents are not available in all areas of the country.

Other approaches have been described in the patent literature. U.S. Pat. No. 5,555,664 discloses a device for attracting animals. It includes a provision for a radio-controlled mechanism to operate stimulators, including rattling antlers and scent sprays. A scent-containing bottle is operatively joined to a pressurized aerosol spray canister. Transmitted radio signals operate the scent-dispersing mechanism. U.S. Patent Application US 2004/0064995 discloses dispersal of animal scents in liquid bubbles. The bubbles are created by hand operations. U.S. Pat. No. 5,970,643 discloses a fan designed to assist in removal of scent from a liquid-retaining sponge member. A flow of air is directed over the sponge member and liquid in the sponge generates an odor to attract animals. U.S. Pat. No. 6,550,689 discloses an animal scent-dispersing apparatus for laying a scent trail while a user is walking to a selected location. It includes a liquid-absorbing dragging material with a container or animal scent. The container includes a spraying mechanism to release the scent from the container and onto the dragging material.

What is needed is a device for spraying animal scents that is simple to manufacture and use, that requires minimum maintenance, and supply of parts and that affords maximum versatility in selection of scents and pattern of dispersal.

### SUMMARY OF INVENTION

A pump, battery, remote control unit, and reservoir mounted inside an enclosure are provided. The inlet of the pump receives liquid containing a selected scent. Alternatively, the pump may be replaced by a compressed gas cylinder, the outlet of which is connected to a solenoid valve. The liquid is contained in a reservoir. The outlet of the pump is attached to a misting nozzle, which is mounted outside of the enclosure. The pump is electrically connected to the battery. The enclosure may be attached to an object such as a tree using a mounting strap that may be provided with the enclosure. A hunter may activate the pump via remote control. Instead of a remote control operation, operation of the motor may be activated by wireless motion detectors or by a timer, which are well known in the art. The nozzle then disperses particles of the liquid (usually containing pheromones) into the air around the desired area.

### BRIEF DESCRIPTION OF THE DRAWINGS

Referring now to the drawings, the details of the preferred embodiments of the present invention are illustrated.

FIG. 1 is a sketch of one embodiment of components of the scent dispersal system.

FIG. 2 is a schematic of one embodiment of an electrical circuit for operation of the system.

FIG. 3 is a drawing of the system in operation when attached to a support.

FIG. 4 is a sketch of one embodiment of the components of the scent dispersal system.

FIG. 5 is a sketch of one embodiment of the components of the scent dispersal system.

FIG. 6 is a schematic of one embodiment of an electrical circuit for operation of the system.

FIG. 7 is a drawing of the system in operation when attached to a support.

### DETAILED DESCRIPTION

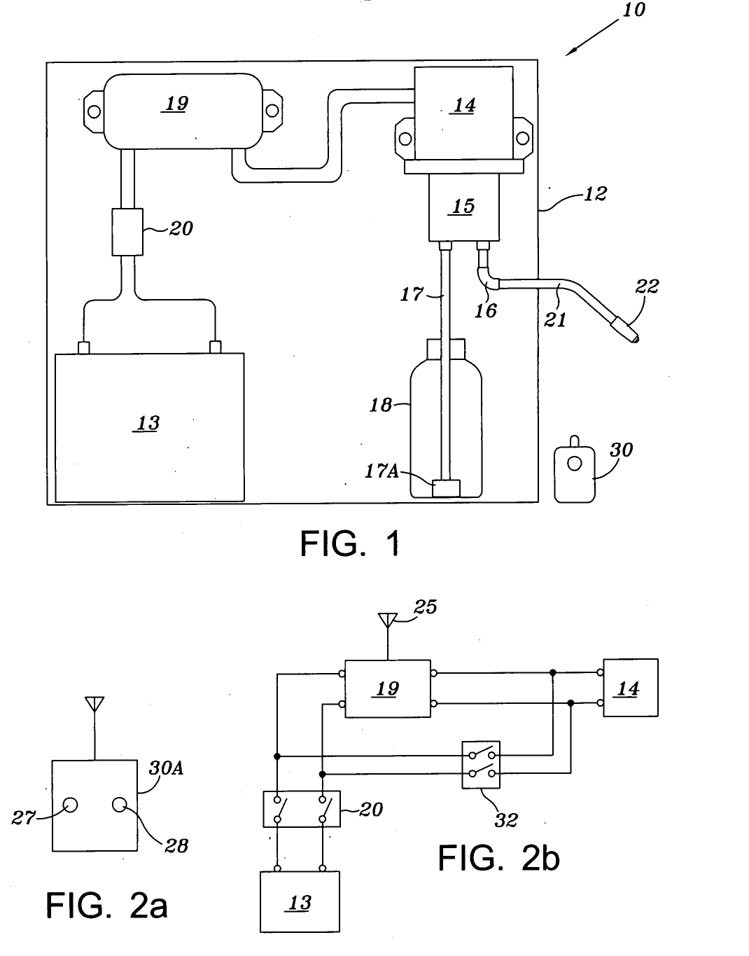

Referring to FIG. 1, scent-disperser system 10 is shown. Case 12 encloses some of the components of the system. Enclosed is battery 13, which may be a rechargeable battery. A battery charger (not shown) may be enclosed within case 12 or may be externally connected to battery 13. The battery charger may be solar powered. Motor 14 drives pump 15, which is used to disperse a liquid through outlet tube 21 and nozzle 22. Outlet tube 21 may connect to a plurality of tubes and nozzles 22, which may be arranged in a preferred pattern around case 12.

Pump 15 receives liquid through inlet tube 17, which may include filter 17A. The distal end of tube 17 is immersed in the liquid in container 18, which may be a 4 oz. bottle adapted to receive tube 17. Multiple reservoirs for different scents may be included within cabinet 12. Motor 14 may be activated when a radio signal is received by receiver 19. Receiver 19 may include a timer that provides an output voltage for a specific time, such as 5 seconds. The timer may be adjustable for varying time intervals. On/off switch 20 may be used to disconnect battery 13 when the system is not in use.

FIG. 2b shows a sketch of the electrical circuit for one embodiment of system 10. Battery 13 connects to switch 20, which may be used to deactivate the system or turn it off when not in use. Radio receiver 19 provides power from battery 13 to motor 14 when activated by receipt of a radio signal at antenna 25. Sending unit 30A (FIG. 2a) may be used to activate motor 14 by operating button 27 or 28. As an alternate method for activating pump 14, timer 32 may be connected and provide power from battery 13 to motor 14 when timer 32 establishes electrical connection. Timer 32 may be set for time of connection and duration of connection. Extra buttons, such as 27 or 28, may be used to activate other apparatus attached to and operated along with unit 10 or one button may be used to activate multiple units. One such other apparatus may be a built-in speaker for game calls. Game calls may be provided by digital recordings, as is well known in the art, and may be remotely activated.

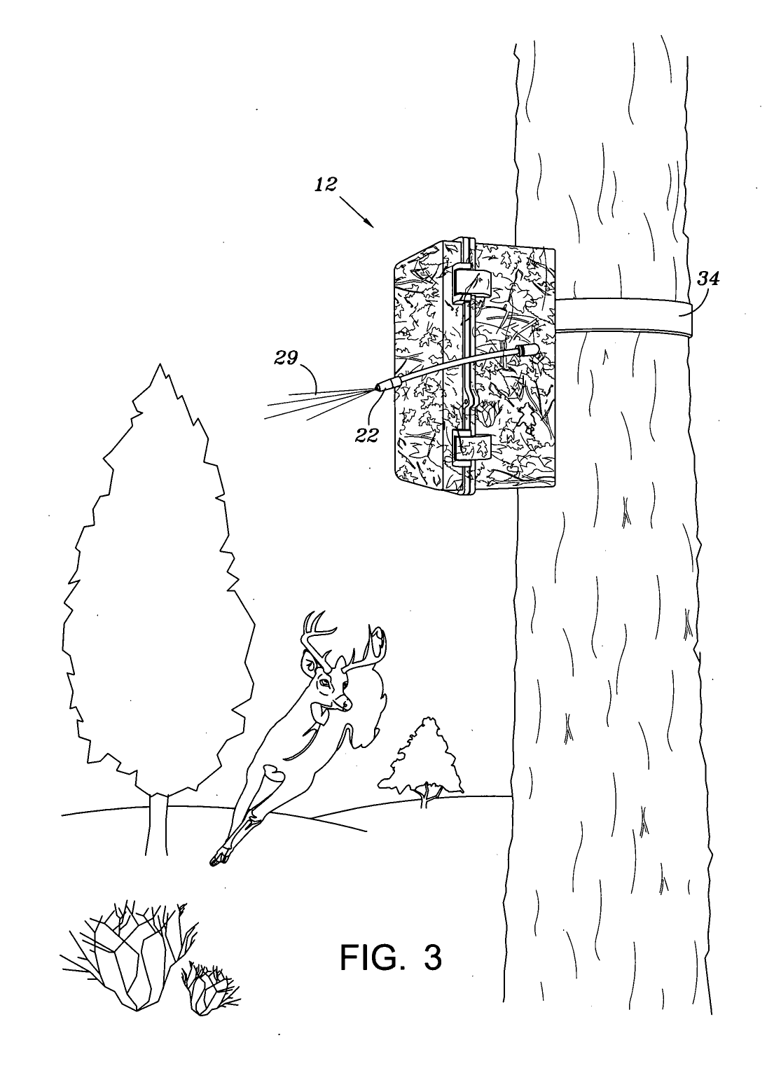

FIG. 3 shows cabinet 12 of system 10 attached to a tree using strap 30, which may be furnished with system 10. Nozzle 22 is shown providing spray 29. Case 12 may be colored in a camouflage manner as shown.

Battery 13 is preferably a 12 volt battery having a capacity of at least 1.3 ampere-hours. Such batteries are available from a variety of sources. Preferably such battery may be charged and discharged numerous times to provide a long lifetime source of power.

Motor 14 and pump 15 preferably provide a selected output pressure of liquid at a selected flow rate. Preferable flow rates are normally in the range from about 0.2 oz./min to about 1 oz./min. A minimum pressure from pump 15 is preferably selected to produce a spray from a selected nozzle size. For example, a nozzle having an orifice of 0.015 inch was found to require a pressure of at least about 45 psi at a flow rate of about 0.5 oz/min to produce a spray of fine particles. Nozzle 22 may be selected from orifice sizes commonly available in industry. The pump is preferably a commonly used DC powered pump-motor combination with at least about 35 psi output at a selected flow rate. Motor efficiency is desired to conserve battery power.

Inlet tube 17 (FIG. 1) is preferably plastic tubing. Attached to the distal end of tubing 17 is preferably filter 17A. Filter 17A may be a filter commonly used for liquids. The filter will decrease the probability of clogging of nozzle 22. A 4 oz bottle is suitable for vessel 18.

Remote receiver 19 is of the type that is commonly available and used for car alarms, door locks, and other remotely operated apparatus utilizing DC power. It may be activated by key chain remote transmitter 30 (FIG. 1) or other transmitters known in the art.

Alternatively, motor 14 and pump 15 may be replaced with gas cylinder 100 or 200. Gas cylinder 100 or 200 contains pressurized gas, which is preferably carbon dioxide (CO₂), but may be any other legally permissible gas. Gas cylinder 100 or 200 is attached to pressure regulator 102 or 202, which controls the pressure of gas released from cylinder 100 or 200. Valve 104 or 204, which is preferably a solenoid valve, controls release of pressurized gas from gas cylinder 100 or 200. When activated, solenoid valve 104 or 204 releases gas from gas cylinder 100 or 200 such that the scent in container 18 is released through nozzles 122 or 222. Solenoid valve may be activated by remote control receiver 22, which is preferably controlled by a handheld transmitter.

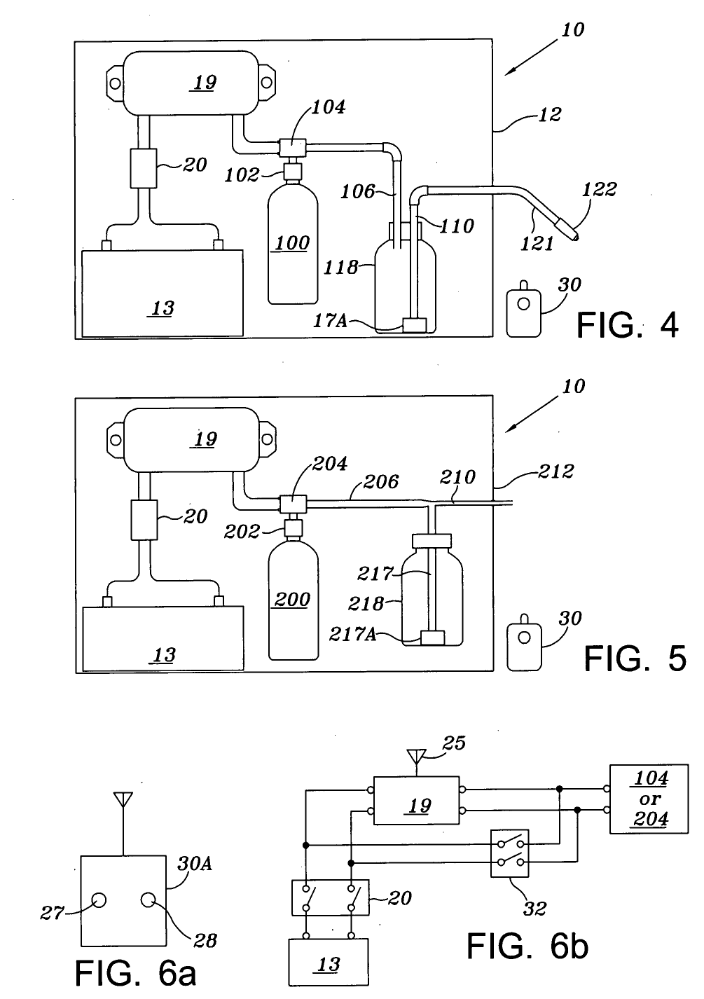

FIG. 4 shows a sketch of one embodiment of the disclosed system 10. Case 12 encloses some of the components of system 10. Enclosed is battery 13, which may be a rechargeable battery. A battery charger (not shown) may be enclosed within case 12 or may be externally connected to battery 13. The battery charger may be solar powered. Pressurized gas from cylinder 100 is used to disperse a liquid through outlet tube 121 and nozzle 122. Outlet tube 121 may connect to a plurality of tubes and nozzles 122, which may be arranged in a preferred pattern around case 12.

Cylinder 100 contains pressurized gas. The preferred gas is carbon dioxide (CO2), but other gases may be substituted. Pressurized gas is held in cylinder 100 by valve 104, which is preferably a solenoid valve. Pressure regulator 102 is preferably placed between cylinder 100 and valve 104 to control the pressure released so that it does not exceed the capacity of system 10. When valve 104 is opened, pressurized gas at an appropriate pressure is released into tube 106. The gas travels down tube 106 to container 118, which contains the scent to be dispersed. The distal end of tube 17, which may include optional filter 17A, is immersed in the liquid in container 118, which may be a 4 oz. bottle adapted to receive tube 17. Multiple reservoirs for different scents may be included within cabinet 12. The scent is pushed through tube 110, optionally through filter 17A. Tube 110 carries the scent to one or more outlet tubes 121 and nozzles 122.

Valve 104 may be activated when a signal is received by receiver 19. Receiver 19 may include a timer that provides an output voltage for a specific time, such as 5 seconds. The timer may be adjustable for varying time intervals. On/off switch 20 may be used to disconnect battery 13 when the system is not in use.

FIG. 5 shows a sketch of another embodiment of the disclosed system 10. Case 212 encloses some of the components of system 10. Enclosed is battery 13, which may be a rechargeable battery. A battery charger (not shown) may be enclosed within case 212 or may be externally connected to battery 13. The battery charger may be solar powered. Pressurized gas from cylinder 200 is used to disperse a liquid through outlet tube 221 and nozzle 222. Outlet tube 221 may connect to a plurality of tubes and nozzles 222, which may be arranged in a preferred pattern around case 212.

Cylinder 200 contains pressurized gas. The preferred gas is carbon dioxide (CO2), but other gases may be substituted. Pressurized gas is held in cylinder 100 by valve 104, which is preferably a solenoid valve. Pressure regulator 202 is preferably placed between cylinder 100 and valve 204 to control the pressure released so that it does not exceed the capacity of system 10. Pressurized gas is held in cylinder 200 by valve 204, which is preferably a solenoid valve. When valve 204 is opened, pressurized gas at an appropriate pressure is released into tube 206. The gas travels down tube 206 to tube 210 to one or more outlet tubes 221 and nozzles 222. Tube 217 is in fluid communication with tubes 206 and/or 210. The distal end of tube 17, which may include optional filter 17A, is immersed in the liquid in container 118, which may be a 4 oz. bottle adapted to receive tube 17. Multiple reservoirs for different scents may be included within cabinet 12. When pressurized gas is released, liquid is pulled from container 218 and is emitted through tubes 121 and nozzles 122.

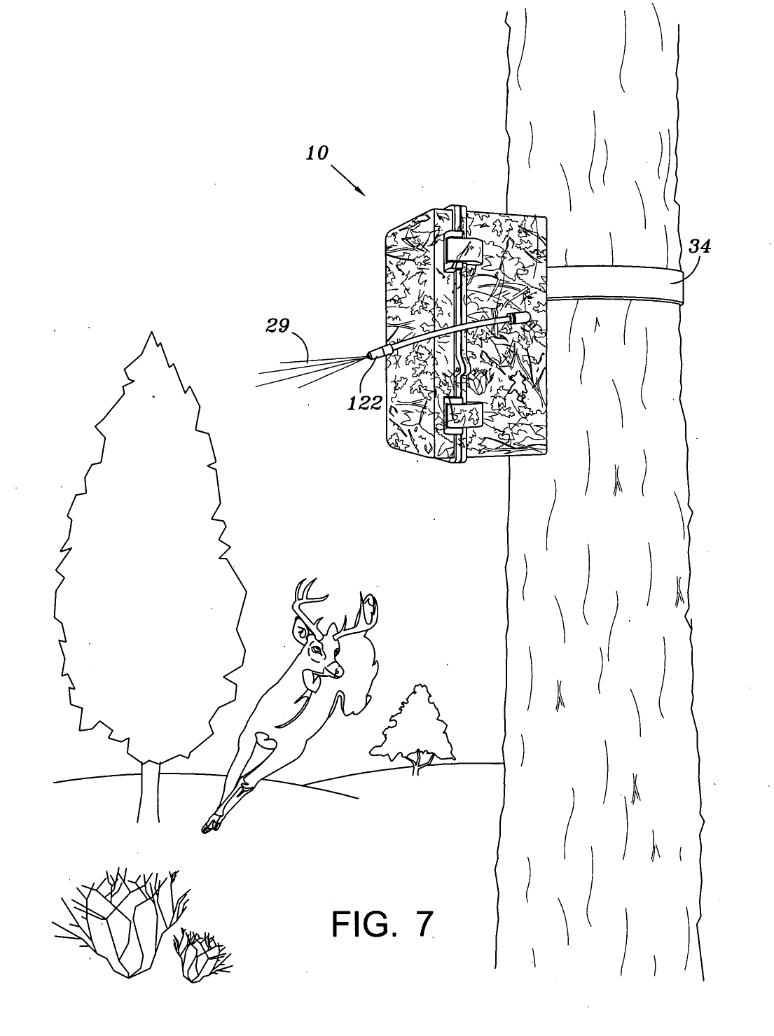

FIG. 6B shows a sketch of an electrical circuit for one embodiment of system 10. Battery 13 connects to switch 20, which may be used to deactivate the system or turn it off when not in use. Radio receiver 19 provides power from battery 13 to valve 104 or 204 when activated by receipt of a radio signal at antenna 25. Sending unit 30A (FIG. 6A) may be used to activate valve 104 or 204 by operating button 27 or 28. As an alternate method for activating valve 104 or 204, timer 32 may be connected and provide power from battery 13 to valve 104 or 204 when timer 32 establishes electrical connection. Timer 32 may be set for time of connection and duration of connection. Extra buttons, such as 27 or 28, may be used to activate other apparatus attached to and operated along with unit 10 or one button may be used to activate multiple units. One such other apparatus may be a built-in speaker for game calls. Game calls may be provided by digital recordings, as is well known in the art, and may be remotely activated.

FIG. 7 shows cabinet 12 of system 10 attached to a tree using strap 30, which may be furnished with system 10. Nozzle 122 is shown providing spray 29. Case 12 may be colored in a camouflage manner as shown.

Although the present invention has been described with reference to specific details, it is not intended that such details should be regarded as limitations on the scope of the invention, except as and to the extent that they are included in the accompanying claims.

I claim:

1. Apparatus for dispersing a liquid for attracting wild animals, comprising:
a case;
a battery;
a pressurized gas cylinder;
a solenoid valve connected to outlet of the pressurized gas cylinder;
a fluid reservoir;
a tube for conveying pressurized gas from the solenoid valve to the fluid reservoir; and
a tube for conveying fluid from the fluid reservoir to a selected nozzle.

2. The apparatus of claim 1 further comprising a receiver for electrically activating the solenoid valve in response to a signal from a transmitter.

3. The apparatus of claim 1 wherein the pressure of the fluid conveyed to a nozzle is selected to produce a spray from the selected nozzle.

4. The apparatus of claim 1 wherein the pressure of the fluid conveyed to the nozzle is at least about 35 psi.

5. The apparatus of claim 1 wherein the nozzle contains an orifice in the range from about 0.006 inch to about 0.020 inch.

6. The apparatus of claim 1 further comprising a battery charger.

7. The apparatus of claim 1 further comprising the transmitter, the transmitter being adapted to operate the receiver.

8. The apparatus of claim 7 wherein the transmitter is further adapted to operate a second device attached to or contained in the case.

9. The apparatus of claim 7 wherein the transmitter is adapted to operate a plurality of receivers.

10. The apparatus of claim 1 further comprising a timer adapted to operate the pump.

11. The apparatus of claim 1 further comprising a pressure regulator.

12. A method for attracting a selected species of wild animals to a selected location, comprising:
placing a liquid attractant for the selected species in the reservoir of the apparatus of claim 1;
placing the apparatus in or near the selected location; and
activating a remote transmitter to produce a spray of the liquid attractant from the apparatus.

13. A method for attracting a selected species of wild animals to a selected location, comprising:
placing a liquid attractant of for the selected species in the reservoir of the apparatus of claim 1;
placing the apparatus in or near the selected location; and
setting the timer to activate the pump at selected times and for selected durations of activation.
